(19) United States
(12) Patent Application Publication
(10) Pub. No.: US 2013/0197902 A1
(43) Pub. Date: Aug. 1, 2013

(54) SYSTEM, METHOD AND COMPUTER PROGRAM FOR SHARING AUDIBLE WORD TAGS

(71) Applicant: Vigen Nazarian, Mississauga (CA)

(72) Inventor: Vigen Nazarian, Mississauga (CA)

(73) Assignee: ANTVIBES INC., Mississauga (CA)

(21) Appl. No.: 13/561,809

(22) Filed: Jul. 30, 2012

Related U.S. Application Data
(63) Continuation-in-part of application No. PCT/CA2011/000097, filed on Jan. 29, 2011.
(60) Provisional application No. 61/299,424, filed on Jan. 29, 2010.

(51) Int. Cl. G10L 21/00

(52) U.S. Cl. CPC G10L 21/00
USPC 704/201

(57) ABSTRACT

The invention provides a system, method and computer program for sharing audible word tags. The word may be an individual's name or information conveyed through series of words. An audible word tag may be recorded by an individual. The audible word tag may be embedded in electronic correspondence and/or documents for sharing with others, or accessed dynamically via the internet and/or other applicable network connectivity on an as-required basis. The method includes generating a profile for associating one or more words to an audible word tag. An audio recording is made of the one or more words. The audio recording is linked to the profile. The audible word tag is linked to one or more electronic correspondence or print. The audible word tag is accessible by a receiver of the correspondence to initiate the playback of the audio recording.

### CROSS-REFERENCE TO RELATED APPLICATIONS

This utility application is a by-pass application and a Continuation-In-Part (CIP) patent application of PCT Application PCT/CA0211/000097, titled “SYSTEM, METHOD AND COMPUTER PROGRAM FOR SHARING AUDIBLE NAME TAGS,” with the International Filing Date Jan. 28, 2011, and published as WO 2011/091516 A1 on Aug. 4, 2011, which claims the benefit of U.S. Provisional Application Ser. No. 61/299,424, titled “SYSTEM, METHOD AND COMPUTER PROGRAM FOR SHARING WORD TAGS,” filed on Jan. 29, 2010, each of the foregoing being hereby incorporated by reference in their entireties.

### FIELD

This present invention relates to computer network implemented technologies for enabling the pronunciation of words and/or to convey information. The present invention more specifically relates to a computer network implemented system for sharing audible word tags for enabling others to correctly pronounce words or receive information in an audible form.

### BACKGROUND

Globalization has resulted in increased migration, travel and business. As globalization proliferates, individuals of different cultures or linguistic groups tend to come into contact more and more frequently.

Unfortunately, individuals that are transposed or exposed to foreign cultures often have names that are different in constructions from the names of locals. Pronouncing unfamiliar names in everyday life is a regular challenge, but is awkward. Individuals want to use their birth name because this is part of their heritage and their identity, but the reality is that they tolerate constant mispronunciation or localization of their name. For example, to avoid mispronouncing names, people often use nicknames. Even in situations where an individual makes efforts to have their name correctly pronounced by a person, there is a high likelihood that person will mispronounce the individual's name at their next encounter. Conversely, some individuals adopt personalized derivatives over the usual pronunciation of names (for example in the country of origin of the name), which also becomes part of their identity nonetheless.

In both personal and business lives, correct pronunciation of foreign names is seen as a sign of respect and care for individual persons and diversity of cultures. It avoids embarrassment and awkwardness.

In parallel aspects, people often find it hard to pronounce product names, technical names, company names, scientific names, and places (names of geographic locations), etc.

Solutions have been proposed to deal with the issue of familiarizing locals to foreign names. Specifically, websites, including www.pronouncenames.com, www.howtosaythatname.com and www.saythatname.com provide phonetic spellings of names. However, people are required to have prior knowledge of these resources and to spend time and efforts to navigate to these central directory sites to learn the names, a task that is typically not taken on. Therefore, it is apparent that these resources do not provide instant, or local access on a given electronic device (for example a personal computer or mobile phone), to a third party person's information such as the preferred pronunciation of the name. It is also evident that these prior art solutions generally do not provide the preferred pronunciation of a name by the person to reflect the preference in emphasizing subtle intonation of accent, inflection and tone for letters or syllables in a given word. Nor do these solutions address the increasing personalization by individuals of the pronunciation of names, as compared to the usual pronunciation in the country of origin for the name. Moreover, these web sites fail to enable the option to allow broadcasting the word preferably in the same voice as the individual much like their “Audio DNA”, their true, identical “Voice Print”.

There is prior art related to generating greeting voice mail greeting messages. For example, United States patent publication 20090190728 to Lucent Technologies is directed to a system and method for providing a user with an accurate audible pronunciation of a person's name in a non-call environment using the spoken name pre-recorded and saved at the person's voice mail system. As such, a person would be required to call into the individual's voice mail to determine the correct pronunciation of the individual's name. There are further patents and patent applications that are directed to the field of telephony. However, none of these is directed to providing others with the customer's pronounced name.

Information sharing and exchange have proliferated in the age of the Internet. People and strangers from all corners of the world are connected quickly and often through emails, instant messaging, social media, etc. While this sharing and exchange is very efficient, the process lacks a human touch as the sharers may forever be unknown to each other. One solution is offered by GRAVATAR™ which provides personal photo sharing to add human content in digital communication. However, a more human connection can be made by sharing the real voice of a person saying his/her name, providing information about him/her or information on subjects of interest to him/her. This is because people respond to voice which can convey emotion, personality or authority.

Digital media can add life to text by directly linking additional information through hyperlinks. In contrast, print media has remained static and non-engaging. The use of QR codes has enabled print media to reach additional information such as a website.

What is required is a means for providing attributes for a given name, word or series of words that allows instantaneous access to information as required, reflecting the preferred intonation and in the same voice as the individual as if he/she was present in a room, or hearing directly the information in the same voice as the individual as if he/she was present.

What is also required is a platform that managed the creation and distribution of such audible content in a scalable and efficient way, from a multitude of network-connected devices.

### SUMMARY

The present invention provides a system, method and computer program for sharing audible word tags.

The present invention also provides a computer implemented method for sharing an audible word tag for one or more words, the method comprising: (a) generating a profile for associating one or more words to an audible word tag; (b) recording an audio recording of the one or more words; (c) linking the audio recording to the profile; and (d) linking, or facilitating the linking, by one or more computer processors, the audible word tag to one or more items of electronic correspondence, the audible word tag accessible by a receiver of the electronic correspondence to initiate the playback of the audio recording.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology [singular or plural forms of word] and terminology employed herein are for the purpose of description and should not be regarded as limiting.

### BRIEF DESCRIPTION OF THE DRAWINGS

FIG. 1a illustrates an audible word tag system in accordance with the present invention, in one embodiment thereof.

FIG. 1b illustrates and audible word tag system in accordance with the present invention, in another embodiment thereof.

FIG. 2 illustrates a method to configure an audible word tag in accordance with the present invention.

FIG. 3 illustrates the audible word tag of two words linked to the audio recording of the word, a textual phonetic representation of the word, and an accompanying picture.

FIG. 4 illustrates the audible word tag being embedded directly into the signature provided by an email application.

FIG. 5 illustrates the audible word tag being made available through a web link to access the audible word tag through a web server.

FIG. 6 illustrates the audible word tag being embedded using a proprietary attachment feature for an email application using for example an API of the email application.

FIG. 7 illustrates the audible word tag being directly embedded into the body of the email.

FIG. 8 illustrates the audible word tag being directly embedded as an audio file attachment.

FIG. 9 illustrates the audible word tag being embedded or accessible through a social networking application or web page.

FIG. 10 illustrates the audible word tag being embedded or accessible through a second social networking application or web page.

FIG. 11 illustrates the audible word tag being embedded into an instant messaging application.

FIG. 12 illustrates an example of the registration process associated with creating a profile in accordance with the present invention.

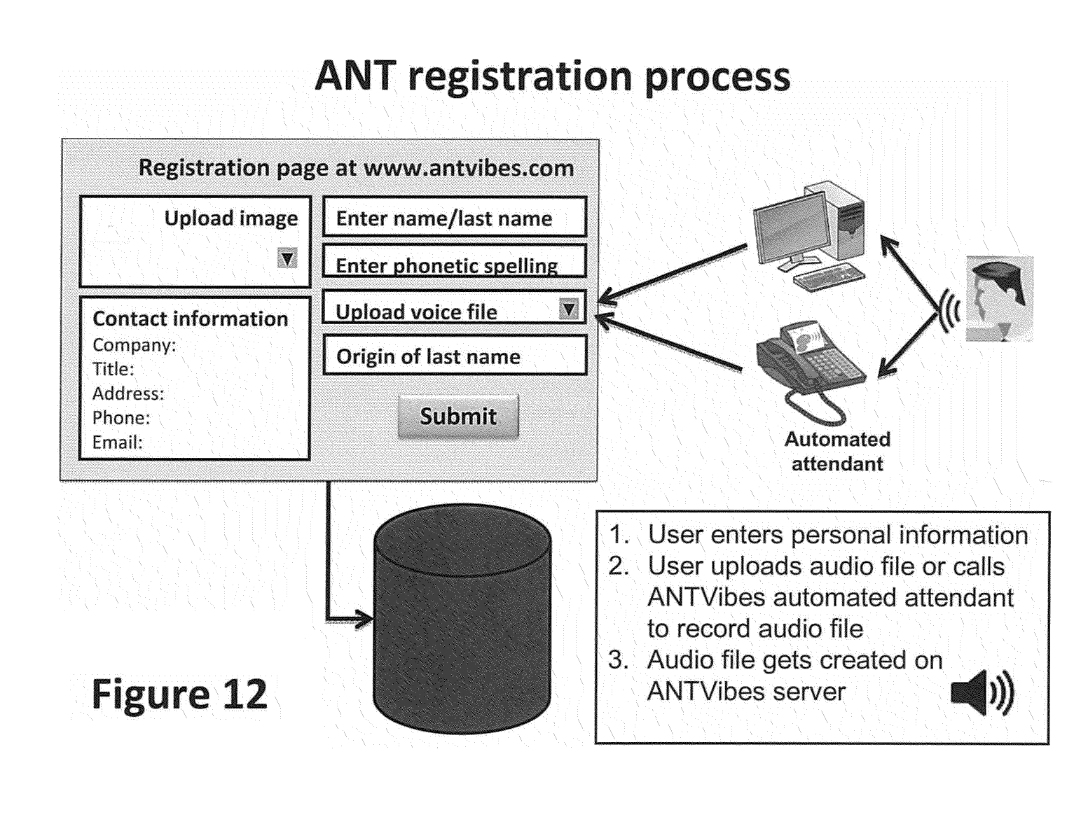

FIG. 13 illustrates another representative implementation of the present invention, using a QR barcode as a web link to the system of the present invention.

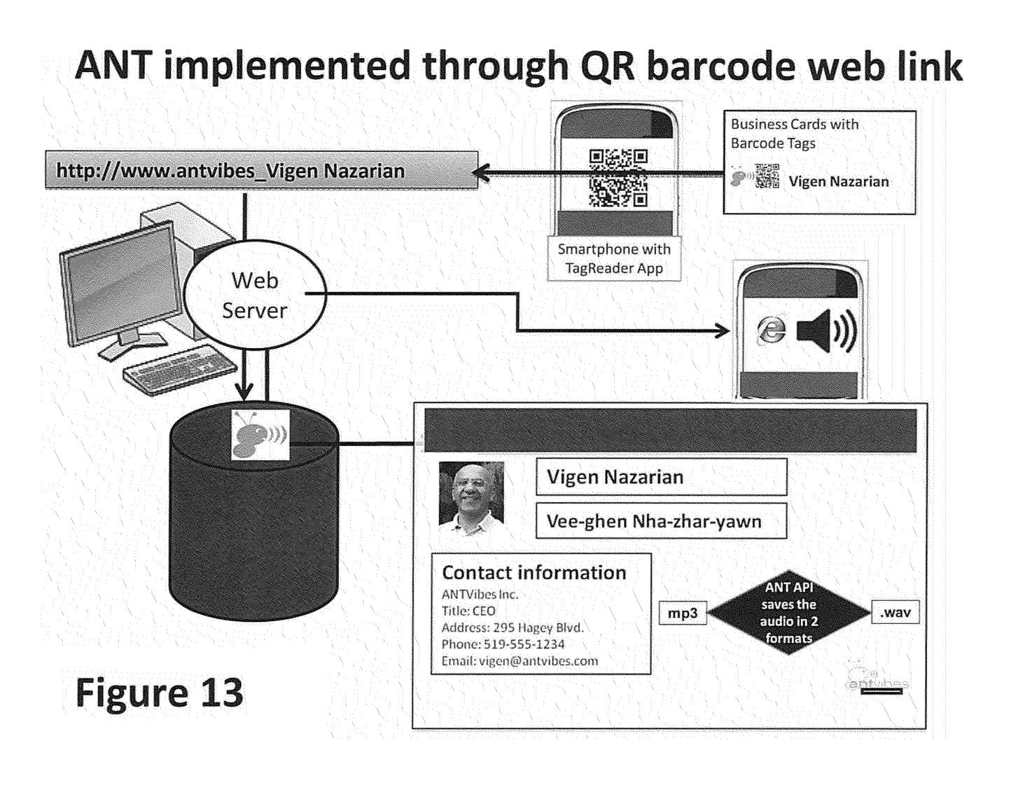

FIG. 14 illustrates one particular implementation of the present invention, showing the storage of the audible word tags in multiple formats in order to enable access in different formats, from different devices.

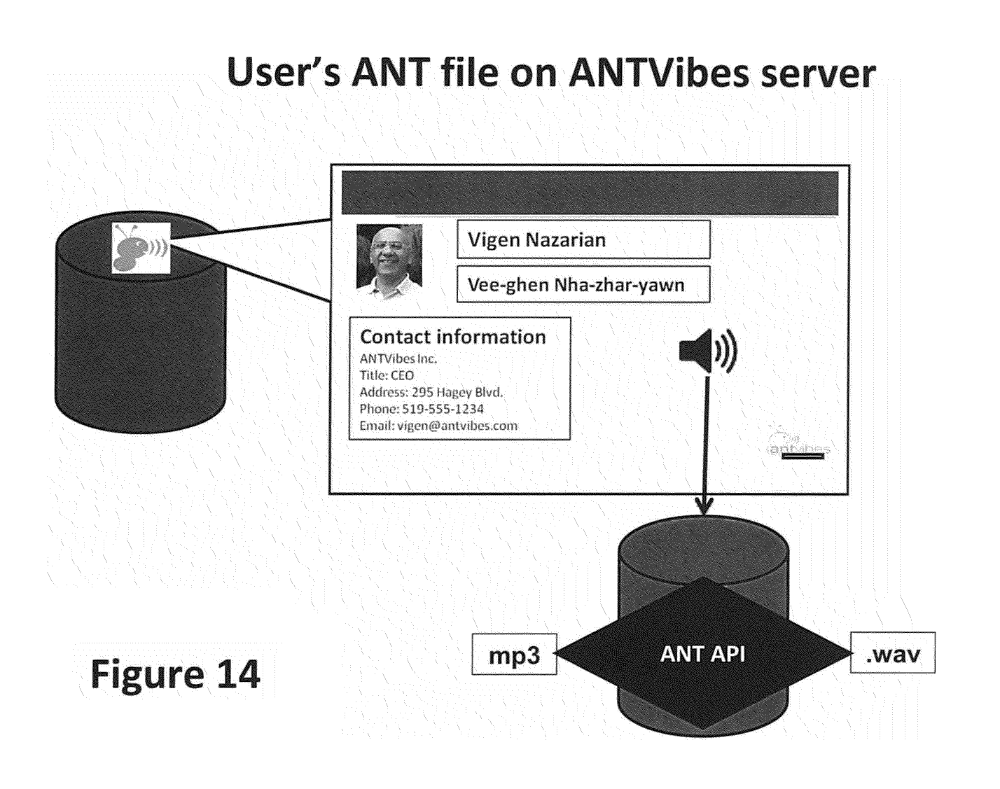

### DETAILED DESCRIPTION

The present invention provides a computer system, method and computer program for sharing audible word tags. The audible word tags may consist of one or more words in audible form, for example an individual's name (and other related information), a personal greeting, a personal description, a short biography, product description, a recommendation, or other audible material.

One of the insights of the inventor is that audible content can provide greater immediacy to a variety of electronic media objects (such as for example email, web pages, micro sites linked to print promotions for example using scannable digital codes such as QR codes or similar codes such as the MICROSOFT™ bar code system). However, there is a need for an easy to use mechanism for capturing audible content, and also to distribute the audible content across different communication platforms and different network-connected devices, in a way that reflects the cross-platform nature of Internet publishing, and also the tendency to reuse digital content in different forms. For example, promotions now tend to be implemented across web media, mobile media, and social media, targeting users by generating a similar promotional message whether the user is accessing the message from a desktop computer, tablet, smart phone, or within a 3rd party social networking environment.

The inventor has therefore developed (A) novel and innovative digital media objects that consist of or incorporate audible word tags, and (B) a novel and innovative computer system, implemented as a flexible and scalable Internet platform for creating and distributing (through a variety of communication channels) digital media objects that consist of or incorporate audible word tags, in a way that provides access to the audible word tags in a way that is optimized by the computer system for a variety of different network-connected devices (“content distribution platform”).

The present disclosure refers primarily to “audible word tags”, or “audible tags”, but also sometimes to “audible name tags” which indicates an example of an “audible word tag” that relates to an individual's name, as explained below. A skilled reader will understand that various types of audible word tags are possible, as are various applications of audible word tags. For example, this disclosure also refers to “audible promotional tags” which is an audible word tag that is linked to a particular product or service. Other uses of audible word tags may include “audible information tags” (for example for linking audio information to a museum display object for example), or “audible greeting tags” (for example an audible greeting that is linked to a physical location such as a greeting from a celebrity that is associated with a store).

Content Distribution Platform

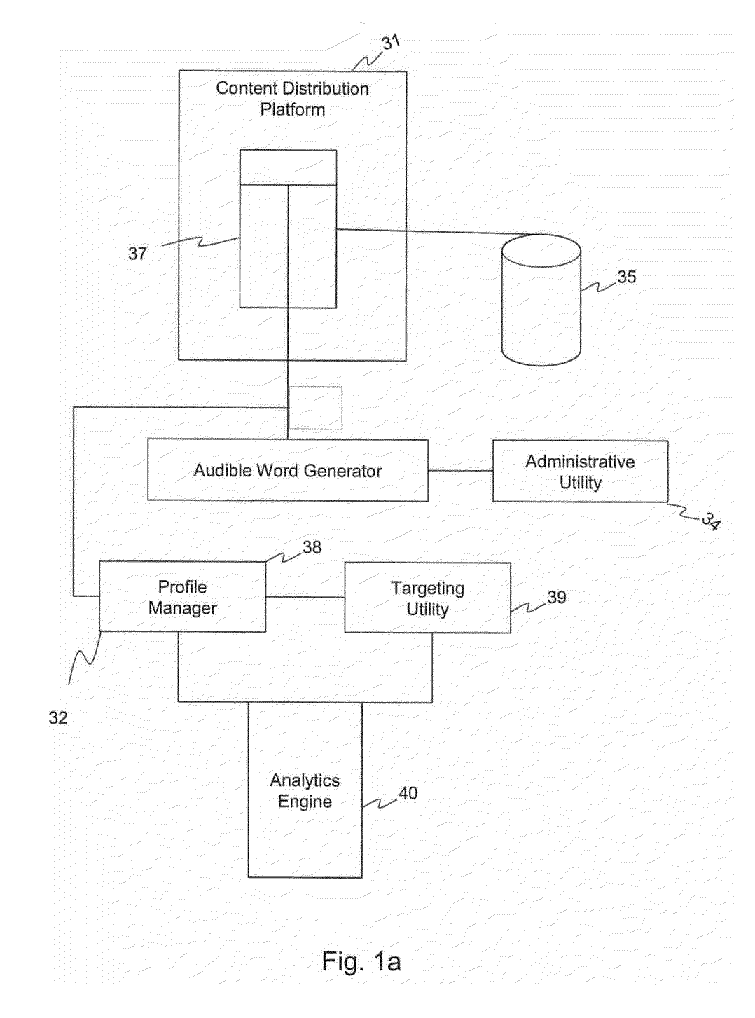

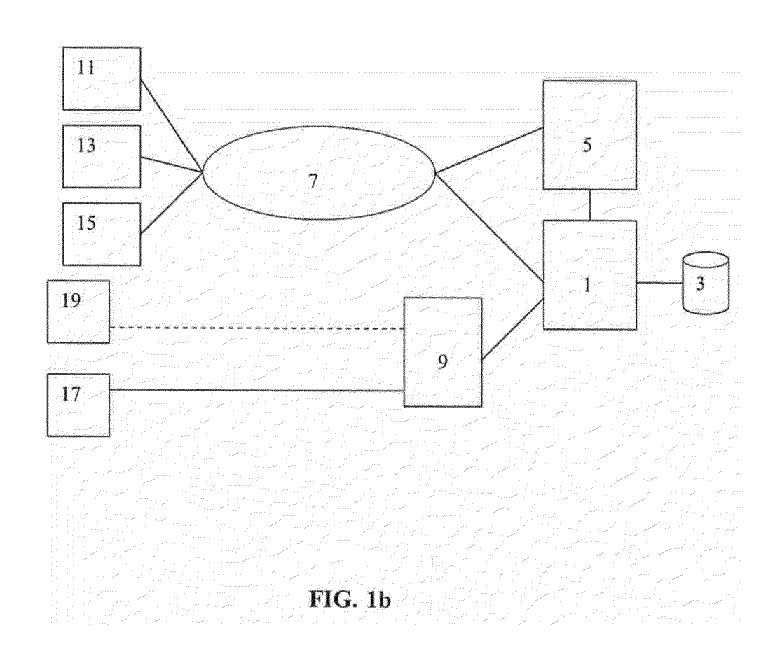

In one aspect of the invention, a novel and innovative content distribution platform (31) is provided, as shown in FIG. 1a. In one implementing, the content distribution platform includes: (A) one or more tools for enabling the capture of audible content, and logging of the audible content to a database as an audible word tag (in the format further described below), also referred to as an “audible word generator”, and (B) an administrative utility (34) that enables one or more users to define parameters for enabling the distribution of the audible word tags, including across different communication channels and across different network-connected devices.

In one aspect of the invention, the content distribution platform (31) may include a content delivery optimizer that embodies one or more techniques for optimizing the delivery of audible word tags, depending on the relevant communication chancel and relevant network-connected device associated with a user sending a request to receive the audible word tags from the content distribution platform (31).

In one implementation of the present invention, a content delivery optimizer may include one or more technologies or processes that (A) detects one or more parameters associated with a network-connected device being used by a user who wishes to access audible word tags, (B) optionally detections one or more network performance parameters affecting the network-connected devices, (C) based on (A) and optionally (B) establishes one or more system parameters for delivering audible word tags to the network-connected device in an optimal way, and (D) uses the system parameters to deliver the audible word tags to the user's network-connected device. Based on use of the content delivery optimizer, the computer system of the present invention may for example (A) compress audible word tags, (B) applies one or more network optimization techniques such as bonding of connections, or (C) improves or decreases sound quality.

In one aspect of the invention the content distribution platform (31) either includes or is linked to a content management system (“CMS”) such as those used by brands or advertising companies to manage content used in various promotional campaigns, and the distribution of this content, including across multiple communication platforms and different network-connected devices. A CMS incorporating the content distribution platform of the present invention, enables audible word tags to be used for example in various promotional campaigns in a way that engages a target audience better and provides access to information in a way that creates more immediacy. The use of the content distribution platform (31) also enables promotional campaigns that can leverage for example the recognized voice of a media personality to enable better leverage for example of sponsorship or endorsement partnerships with media personalities, by providing a new mechanism to capture and distribute audio content in a scalable and effective way.

In another aspect of the invention, the content distribution platform (31) is configured to associate a unique identifier with each audible word tag. This unique identifier is also stored to the database (35), and then is used by the content distribution platform (31) to generate digital code for requesting a particular audible word tag based on the unique identifier. As further explained below, the digital code may consist of (A) an embedded code for accessing an audible word tag, (B) a web link for requesting an audible word tag from a web server (37), or a scannable digital code which may be used using a scanning application loaded on a mobile device for example, that enables the mobile device to send a request to the web server (37) to make a particular audible word tag accessible using the mobile device.

Examples of media linked to or incorporating audible word tags based on the present invention are provided below.

One advantage of the content distribution platform (31) of the present invention is that print media or digital media can be enlivened by adding voice much as adding voice makes movies more engaging. Another advantage of the present invention, is that an online platform is provided that (A) enables multiple users to contribute audible content, (B) that tracks potentially large inventories of audible content, (C) that enables users to integrate audible content in other content, for example in connection with promotional campaigns, in an easy to use and flexible manner, (D) assumes responsibility for enabling the delivery of audible content through a variety of communication channels, and to different types of network-connected devices. This provides significant reduction in the efforts and infrastructure that would normally be required to integrate audible content in promotional campaigns, for example. The platform of the present invention makes widespread use of audible content affordable and practical. This allows users to deploy much more engaging promotional campaigns or information campaigns.

Targeting Using Voice

In another aspect of the invention, audible tags may also be used to convey information in a voice that is pleasing or that provides a mechanism to targets users. For example, a user may be associated with a network-connected device. The operator of the computer system may have means of accessing demographic information for the user (for example based on sign-in to an application or linking the network-connected device to an established profile. Profiles may be managed using for example a profile manager (38), as shown in FIG. 1a.

Based on the profile for a user, and optionally market research, it may be established that certain voice characteristics may be more effective in targeting the user based on their profile. The audible word generator of the platform may be used to generate audible word tags with desired messaging in different voices with different characteristics.

Based on the profile of the user and optionally other information such as location, nature of the product being promoted and so on, a targeting utility (39) may determine one or more parameters for targeting a user using audible word tags, and the targeting utility (39) may perform one or more match operations to the two or more available audible word tags that meet both the content requirements and also match the particular audible word tag that has voice characteristics that would be most effective for targeting the user. An analytics engine (40) may also be leveraged to determine matching criteria to enable effective targeting.

For example, a (A) thirty-five year old male enters a car show room and scans a QR code associated with a particular vehicle using a mobile application that is linked to a profile for the man; (B) the computer system identifies the QR code with the car in question, and access the profile for the man, and determines a set of criteria for matching available audible word tags containing a word description regarding the vehicle to the man for targeting purposes; (C) the computer system determines for the man that a male who sounds knowledgeable about vehicles would have the most impact on this man, for this vehicle. In another case, a female voice providing information regarding the appeal of the vehicle to her may be used to target for example a twenty-two year old man for a different vehicle.

The targeting utility (39) in one implementation, enables the targeting not just based on the selected voice (with different demographic, tone, language or other characteristics) but also based on content conveyed by the recording (more information, less information, more technical, less technical, and so on).

Capture of Audible Word Tags

An audible word tag may be recorded or uploaded by an individual or an automated system. The audible word tag may be embedded in electronic correspondence, documents, media, FLASH, etc. for sharing with others, and/or be dynamically accessible by means of a link in HTML or QR formats for example to a centralized database (35) via the internet and/or other supporting network connectivity. The words may be linked to text, audio, image, or other media.

In one particular aspect, the present invention relates to sharing audible word tags for enabling others to correctly pronounce words and/or learn information. Use of an audible word tag enables individuals to share an audio recording of the correct or preferred pronunciation of one or more words. The one or more words may be the individual's name. The audible word tags may also be used for product names, information or reviews as well as technical names, company names, scientific names, places (name of geographic locations) or any other words. It would be clear to a person skilled in the art, based on the present specification, to implement an audible word tag for a variety of purposes.

FIG. 1b illustrates an audible word tag system in accordance with the present invention. The system may comprise means for storing one or more audio recordings of words as pronounced by one or more individuals and made accessible by an audible word tag. The storage means (3) may, for example, be a database linked to a network (7) accessible computer server (1), which is generally a web server. The storage means enables the storage of recorded audio recordings of words in one or more digital audio formats. A web server (5) may be linked to the computer server (1) for enabling web access to the storage means (3). For example, an individual may access a web site by means of the web server (5). Individuals may access the storage means 3 using a client device via a network connection. It should be understood that an individual may use the microphone or other recording device associated with a personal computer, tablet computer, or laptop computer to record one or more word tags and make the word tags available to the web server 5. The present invention contemplates a client application, loadable on the client device that initiates these steps related to recording of the word tags and making the word tags available to the web server 5.

The audible word tag may be recorded in one of several formats such as for example in an MP3 or WAV format.

Access may be initiated by accessing or linking from an audible word tag. The client device may be a computer (11), wireless network device (13), or VoIP phone (15). The storage means may also or alternatively be linked to a telephone interface (9) for enabling individuals to access the storage means by telephone, including wired (17) or wireless phone (19).

The present invention also contemplates a mobile application of the technology. In one implementation, a user of a mobile device can initiate his/her microphone on his/her mobile device; record an audible word tag; send the audible word tag to the web server (5); the web server (5) associates the email address of the user with his/her profile associated with the web server (5) to include the word tag within the profile defined for the user on the web server, and as described below. The present invention also contemplates a mobile client application that is operable to guide the user through these steps, programmed in a manner that is known. The mobile client application may be accessed from a wireless handheld in a manner that is known, for example, accessing an object in a menu that allows an audible word tag to be attached by a wireless handheld generated email communication.

It should be understood that the present invention may be implemented using a computer implemented attendant in order to guide a user through the steps required in building the profile, including the audible word tags described herein. The attendant may be implemented as part of a mobile client; by accessing web pages via a mobile browser; accessing the attendant using a telephone; or accessing the functions of the attendant via one or more web pages using a personal computer (whether a desktop computer, tablet computer, or other computer).

The present invention also provides a computer implemented method for sharing an audible word tag for one or more words, the method comprising: (a) generating a profile for associating one or more words to an audible word tag; (b) recording an audio recording of the one or more words; (c) linking the audio recording to the profile; and (d) linking, or facilitating the linking, by one or more computer processors, the audible word tag to one or more items of electronic correspondence or electronic media, the audible word tag accessible by a receiver of the electronic correspondence or electronic media to initiate the playback of the audio recording.

The present invention also provides a computer implemented system for sharing an audible word tag for one or more words, by configuring one or more computers to access the audible word tag, the system comprising: (a) at least one computer device configured to enable the generation of a profile for at least one individual, the profile including an audible word tag that enables access to an audio recording personalized by the at least one individual so as to generate an audible word tag; (b) the computer device or another computer device, configured to enable the linking of the audible word tag to one or more items of electronic correspondence, (c) enabling a computer device associated with one or more recipients of the items of electronic correspondence to initiate access to the audible word tag so as to enable the playback of the audio recording.

It should be understood that in one aspect of the invention, the audio recording reflects the individual's voice, and his/her preferred pronunciation of his/her name, as one example of the audible word tag enabled by the present invention. This is significant, as text-to-speech technologies in many cases cannot enable the generation of an accurate, generally accepted pronunciation of a name. Also, often individuals use, or prefer, a particular pronunciation of their names, that may not accord with the pronunciation that another individual sharing the same name may prefer. This aspect of the “personalization” of the audible word tag enables the sender of a communication and the recipient to form and manage their communications and relations better, because it permits the recipient upon meeting or speaking with the sender, for example, to pronounce the words such as the sender's name correctly, and encourage others in their organization or network to do the same. This avoids embarrassment of the sender, in considering whether to correct for example the recipient upon meeting or speaking to one another as to his/her preferred pronunciation of the words represented by the audible word tags. If s/he decides to correct the recipient, this can be embarrassing for the sender and the recipient. Especially where the sender and recipient have been communicating some time electronically, or doing business together, and upon speaking or meeting it becomes apparent that the recipient cannot pronounce the sender's name, or the name of his/her organization correctly, this can be particularly awkward, embarrassing and possibly damaging for the relationship. If s/he decides not to correct the recipient then the mispronunciation may continue and the sender may not be disposed positively toward the recipient.

Conversely, especially with individuals whose names for example are often mispronounced by others, the correct pronunciation of their names can help form a positive impression in the sender about the recipient or his/her organization, for example because the care and attention placed in learning the correct pronunciation of the sender's name shows respect and attention to detail, and thereby assist in forming a stronger personal or business relationship between the sender (and his/her organization) and the recipient (and his/her organization). Particularly in the context of sales efforts directed by the recipient (or his/her organization) to the sender (and his/her organization), the technology described in this disclosure provides a very useful tool in facilitating positive interactions, relationships, and communications in the context of globalization, a mobile workforce, and increasing demand for respect from members of other cultural and linguistic groups of cultural and linguistic attributes such as the correct pronunciation of important words such as the names of individuals or correct pronunciation of company names. Particularly given growing globalization and diversity, the present invention provides significant advantages.

It should be understood that, especially in larger organizations with diverse workforces in a single location, or offices spread across different jurisdictions, the present invention assists in fostering positive working relationships across languages, cultures and geographic regions. More diversity in workforces is also leading to significant efforts being placed in developing and implementing diversity policies. The present invention can play an effective role in such implementation.

The creation and distribution of such audible word tags, however, should be easy and effective. It is important that the audible word tags be made available readily across a multitude of devices and software platforms. The present invention provides a system and method for addressing these requirements.

It is also important to underline, that ready access to the audible word tag, as enabled using the present invention, also provides access to a recording in the individual's voice, which conveys an impression of his/her personality. Increasingly, communications between individuals is conducted by e-mail, texting, and instant messaging. This is convenient, but can be impersonal. The present technology injects into electronic communication a more personal, human link, through access to the “Audio DNA” of the individual by providing ready access to the personalized recording that is part of the audible name tag (for example). Because of the way the present system and method generates audible name tags, and embeds these into electronic or print communications in an efficient way, such that the audible name tags are easily accessible by accessing or retrieving any one of the exchanged electronic communications, the busy recipient can easily access the information, when it is appropriate, on an on demand basis, whether via the electronic communications, or linking of the information for example to a contact list. It is also important to note that some recipients may need to refresh their memory regarding the correct pronunciation; therefore the recipients may want to access the information multiple times. The ready access enabled by the invention, and which addresses the personal preferences of the recipient, in terms of where the information is stored and how it can be accessed, is significant in this regard as well.

It should be understood that in enabling the dissemination of the audible word tags, across different communication methods, platforms, and devices, the present invention plays an important role in instructing interested parties (whether business contacts, co-workers or other contacts) in the proper pronunciation of words that might be otherwise difficult for the interested parties to pronounce. This instruction provides additional benefits outside of those mentioned above including portraying an image of being more linguistically, culturally aware, and more knowledgeable about the business contact, co-worker, or other contact. The invention therefore plays a role in developing a stronger relationship or community with individuals that it is important to strike a relationship with, for a variety of reasons whether personal or business related.

It should be understood, that even outside of a business context, and in social networks of personal nature, the present invention provides a useful tool in fostering social connections and community building.

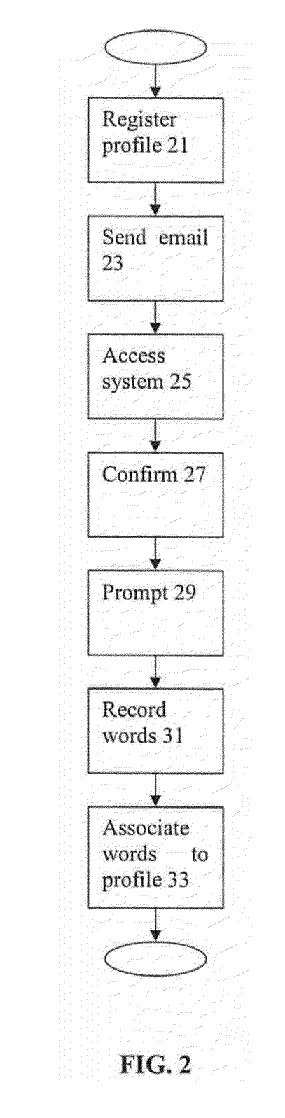

FIG. 2 illustrates a method to configure an audible word tag in accordance with the present invention. The web site may enable an individual to register a profile (21) including an email address. Upon registration, the web server may initiate an email to be sent (23) to the provided email address. The email may include a confirmation number and/or an access means, such as a dial in telephone number. The individual may access (25) the access means from the client device. The individual may be prompted to enter the provided confirmation number (27) and then prompted (29) to record the individual's voice. The individual may then provide the correct or preferred pronunciation of the word (30), such as his or her name. The access means may match the confirmation number to the profile and record in the database the recording of the word or words in association with the profile (21).

An analyzing means may optionally be provided for analyzing the recording and providing a textual phonetic representation of the recorded word. Alternatively, the individual when configuring his or her profile can provide a textual phonetic representation of the word. The individual may also provide his or her picture when configuring his or her profile, for example by uploading the picture to the database. The individual may provide additional information commonly associated with an individual profile such as links to websites, information on occupation, professional associations and the like. In one aspect of the invention, the web server is operable to compile the information regarding the individual, including any audible word tags defined by the individual into a personal profile in accordance with the present invention.

In another aspect of the invention, the web server is operable to generate a data object that includes or links to the personal profile, and may be embedded into electronic communications, such as e-mail. The data object may include or consist of an icon that indicates to the recipients of electronic communications that, for the sender of the communication, a personal profile including one or more audible word tags, in accordance with the present invention, is available.

The audible word tag system may also be implemented to third party web sites including, for example, to web-based email provider sites, or any other site that provides communication and/or profile configuration. Implementation may be enabled by an API provided by the system of the present invention, API provided by the third party, or other means such as integrating the present invention with the service of the third party.

In one aspect of the invention, the web server provides to individuals a series of tools that enable the individuals to configure custom signature data objects into electronic communications, for example, enabling the creation and editing of text, graphics, links (such as to LinkedIn™, FACEBOOK™ profiles or the like), links to feeds, links to latest blog post, inclusion of the personal profile data referred to above (or a subset thereof) management of multiple signature data objects, definition of rules for use of different version of signature data objects based on user defined selections or identity of recipient. However, in accordance with the present invention the signature data objects include the audible word tags described herein, made available in the way described. This collection of information is referred to as “signature data object(s)” in this disclosure.

The audible word tag may be shared by the individual by embedding a link to the audible word tag in emails, email signatures, web pages, electronic letters, electronic documents (for example by assigning the audible word tag with an electronic signature), electronic presentations, virtual cards, etc. This link may be accessed, for example, by clicking on the icon mentioned above.

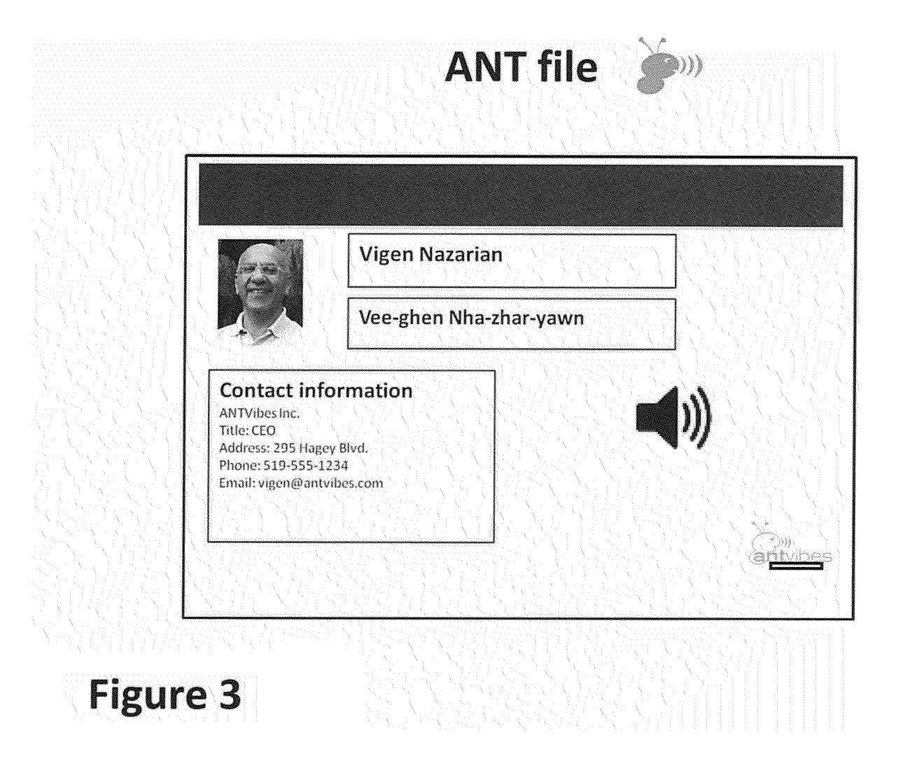

FIG. 3 illustrates the audible word tag of two words linked to the audio recording of the word, a textual phonetic representation of the word, and an accompanying picture. The link may be embedded such that it is displayed to a receiver of the electronic correspondence and/or document. The link may be provided as a linkable text or graphic/icon, for example using HTML. The receiver can click or otherwise activate the link to hear a recording of the audible word tag as recorded in the database. The recording may be transmitted with the link or may be accessed in an on-demand mode, for example by streaming from the storage means if a network connection is present. The textual phonetic representation of the word and/or the individual's picture, if provided, can also be displayed proximate to the link or upon clicking or otherwise activating the link.

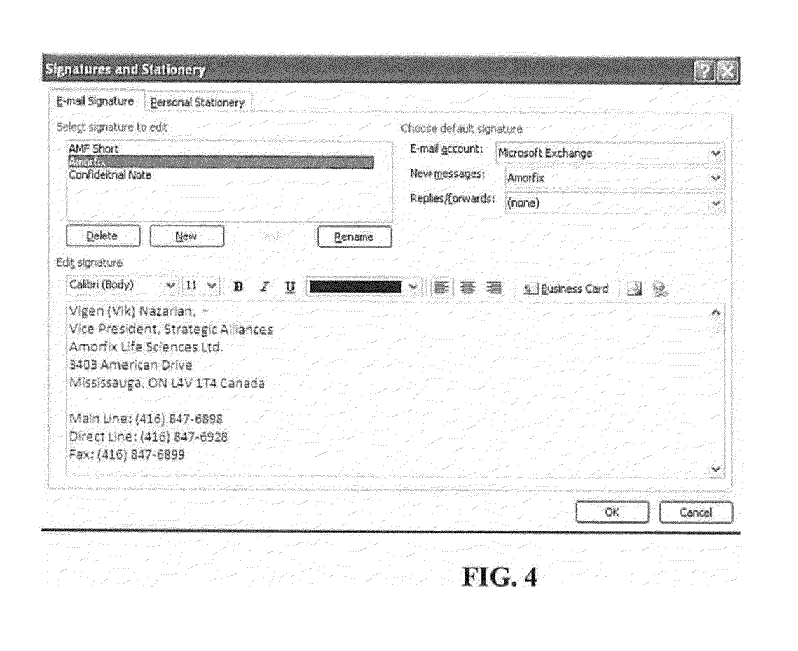

FIGS. 4 to 8 illustrate several means by which to embed an audible word tag into an email. FIG. 4, for example, illustrates the audible word tag being embedded directly into the signature field provided by an email application. A signature configuration utility provided by the email application may enable the audible word tag to be embedded in the signature.

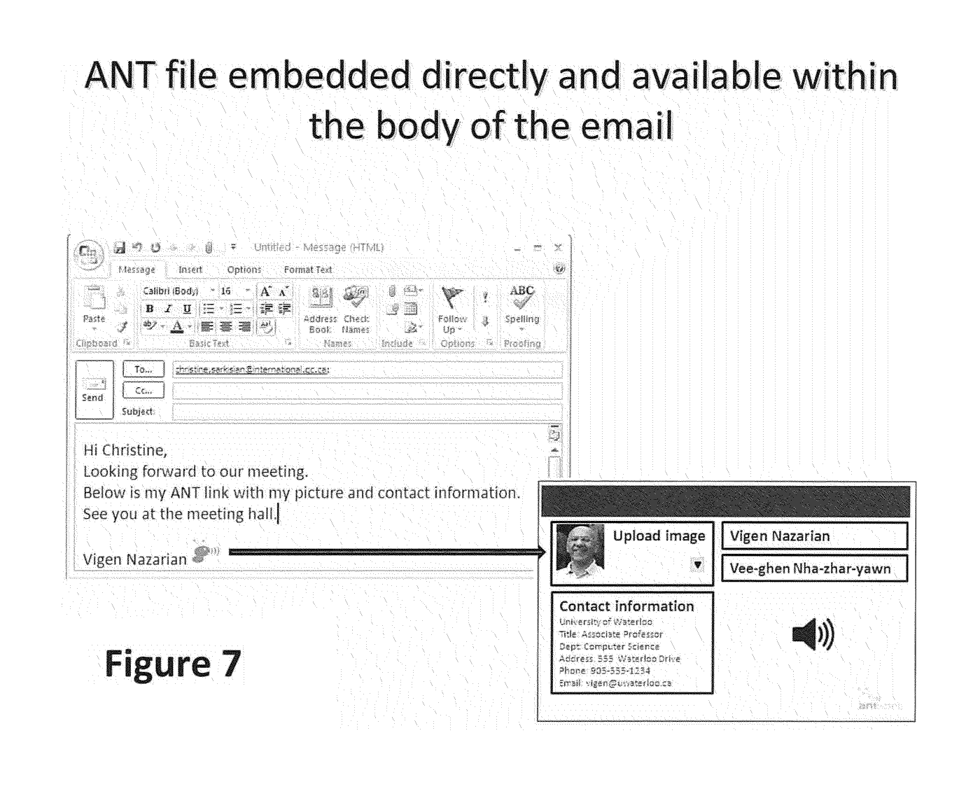

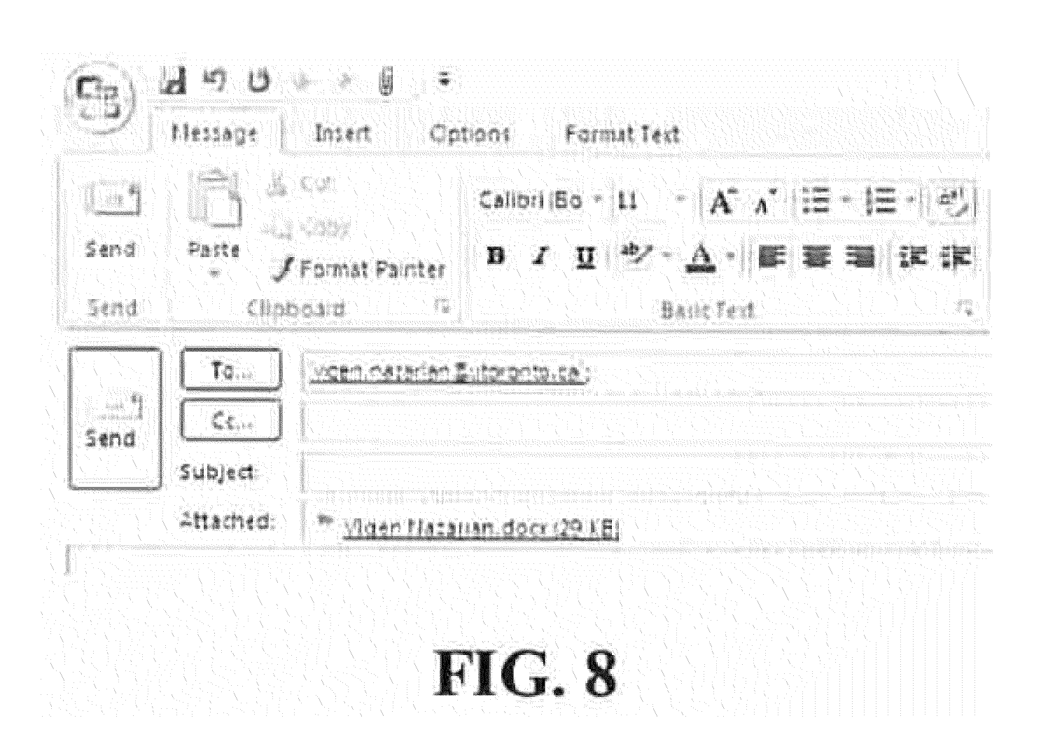

Alternatively, a separate utility may be provided for embedding the audible word tag into an email, instant message, etc. This type of utility may also be used to embed the audible word tag into the body of the message, as discussed in conjunction with FIGS. 7 and 8, below. The separate utility may include an API for enabling the individual to select where they want the audible word tag to appear in relation to the message, whether in the body, signature, etc. and/or when they want the audible word tag to appear, for example immediately following their name, following their name when used in a signature configuration, when used with specific applications, etc. The utility may store a cookie in the message. The message may be sent to a recipient and when the recipient opens the message, a cookie may advise the recipient that the document contains an audible word tag and ask for their authorization to display and/or play the audible word tag. A set of instructions may also be provided to the recipient for playing the audible word tag.

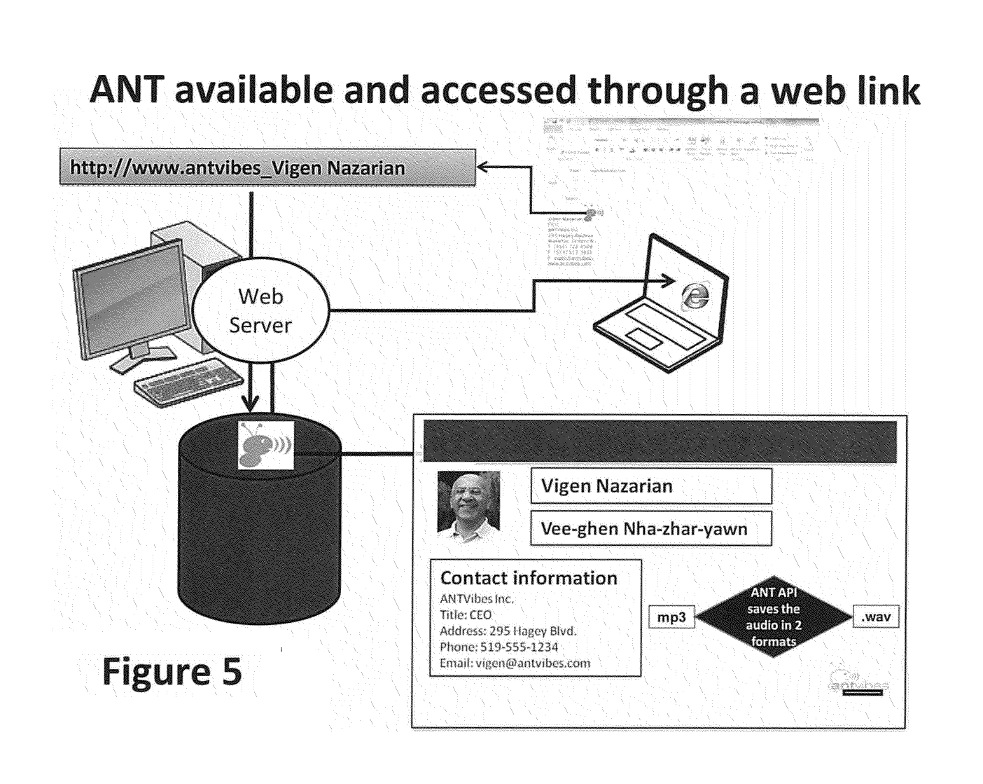

FIG. 5 illustrates the audible word tag being made available through a web link to access the audible word tag through the web server. A link, for example using HTML, may be provided for the audible word tag. When a network connection is present, a receiver may access the link to be provided with playback of the audible word tag.

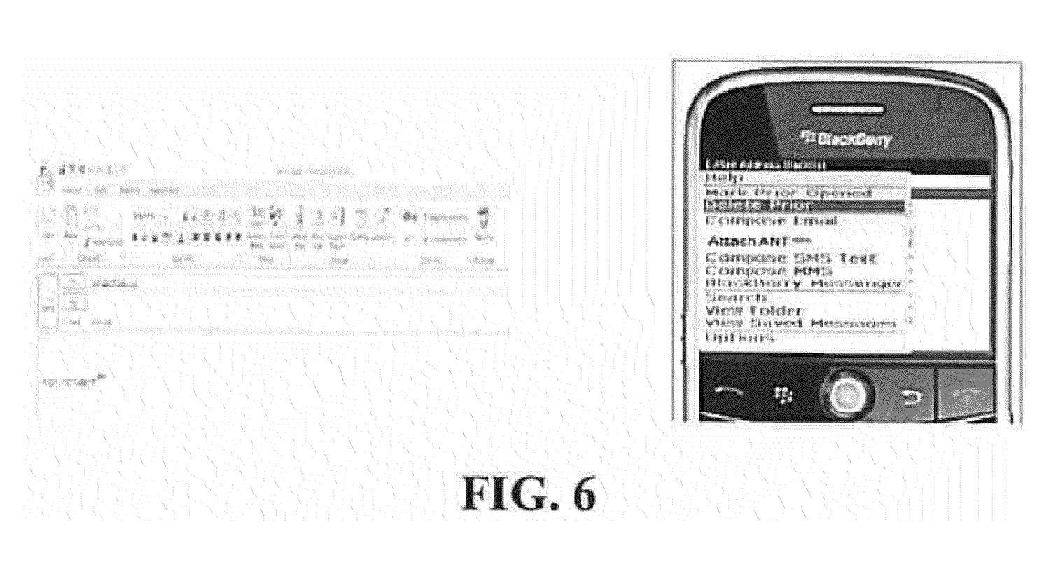

FIG. 6 illustrates the audible word tag being embedded using a proprietary attachment feature for an email application using for example an API of the email application. The feature may be made available through a menu of the email application, as shown, or by any other command means of the email application.

FIG. 7 illustrates the audible word tag being directly embedded into the body of the email. FIG. 8 illustrates the audible word tag being directly embedded as an audio file attachment. Both implementations may be provided by the utility described in conjunction with FIG. 3, above.

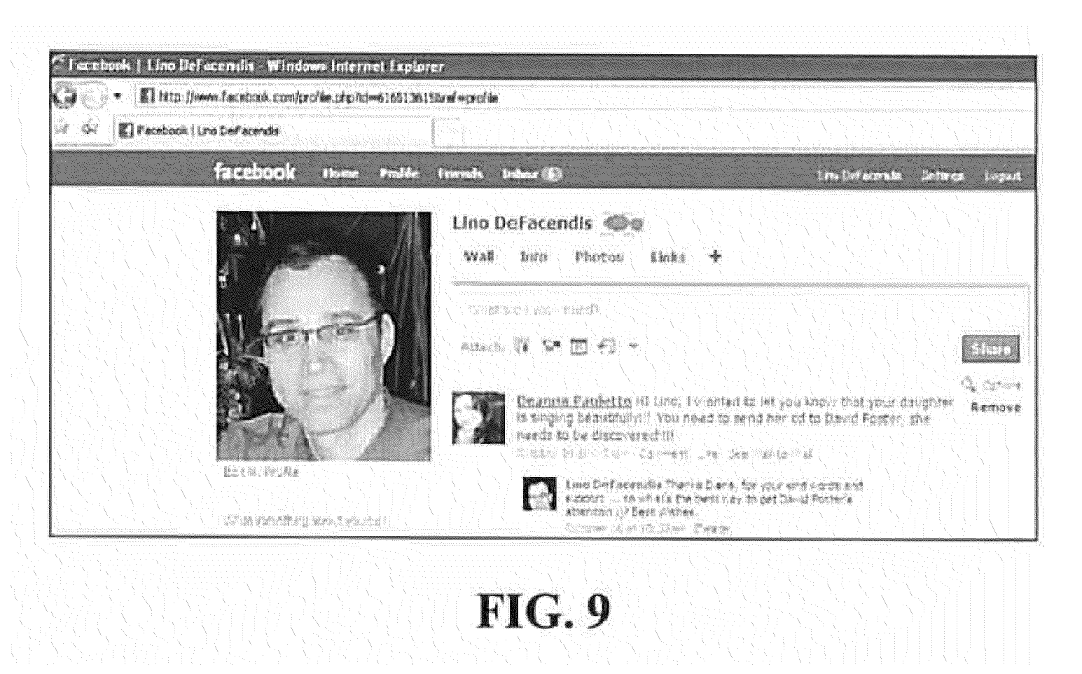

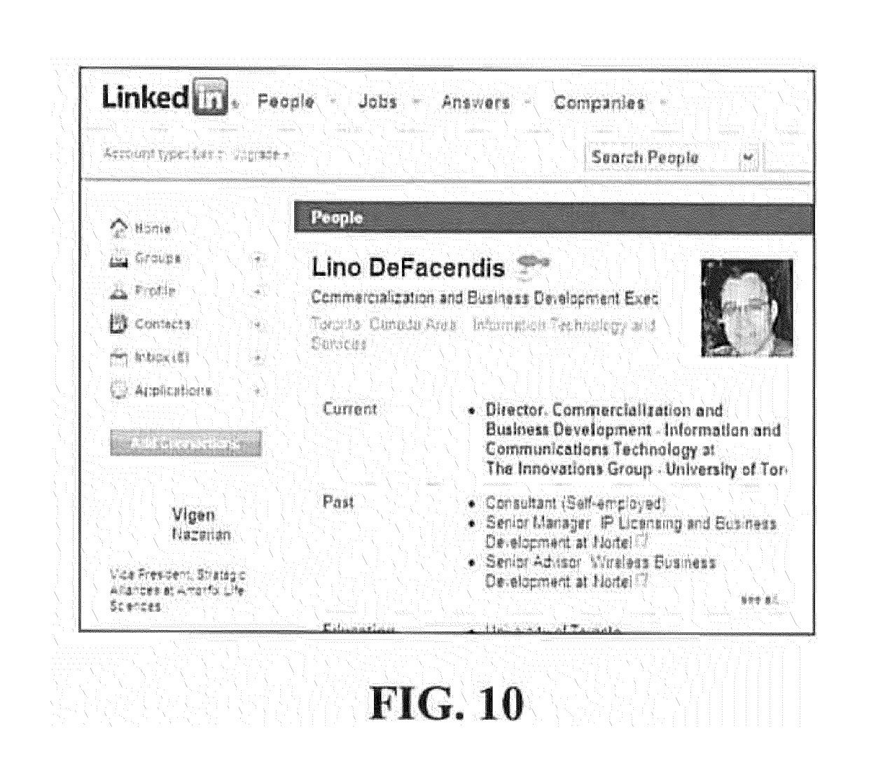

FIGS. 9 and 10 illustrate the audible word tag being embedded or accessible through a social networking application or web page. It could also be placed on any other type of web page, whether social networking or otherwise. It may be provided as a link in the web page itself, or a utility resident on a receiver's computing device could dynamically alter the web page to make the audible word tag accessible.

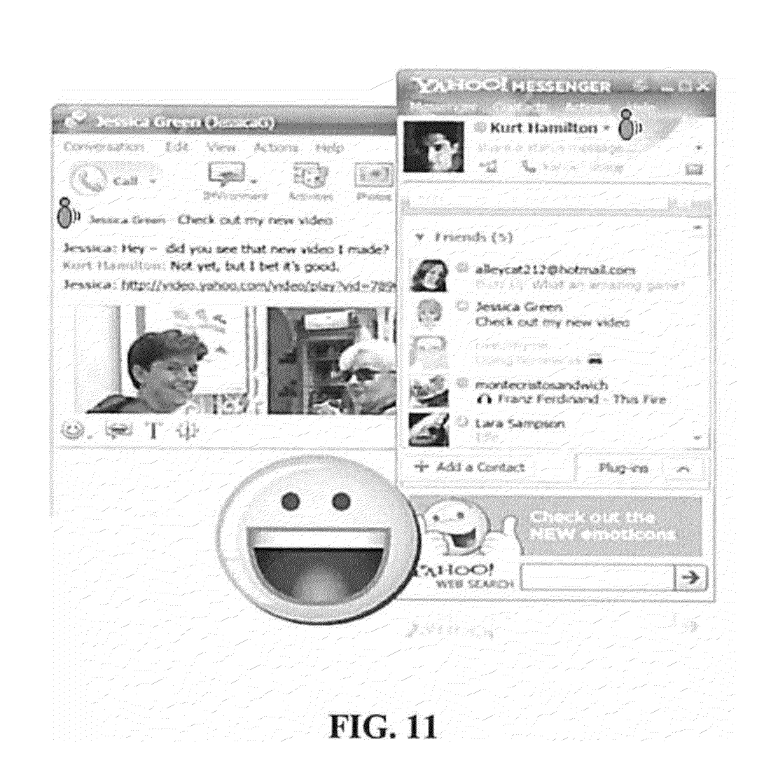

FIG. 11 illustrates the audible word tag being embedded into an instant messaging application. It may be implemented by an API or altering the instant messaging application to support the audible word tag.

The present invention may be implemented as an enterprise network implemented solution, or made part of an enterprise network implemented solution.

For example, in a particular implementation of the present invention, the system may be integrated with a CRM system (customer relationship management) such that records for an individual for example include a link to an audible word tag. Selected entries from the CRM data base may enable access of the audible word tag to remind the user of the pronunciation of the selected words.

It should be understood that the references above to making the audible word tag available or sharing the audible word tag also extends to making signature data object(s) available or sharing signature data object(s), for example, by embedding the same in electronic communications or embedding a link to such signature data object(s) and thereby enabling the same to be accessed using a web server, The signature data object(s) may be presented as a populated snap-shot window, whether the window and its contents are embedded in the electronic communication, or accessed by linking to the web server from a link included in the electronic communication.

The audible word tag may also be enabled by means of one or more cookies linked to a receiving device. The cookie may enable the audible word tag and linked media to be retrieved locally in email or electronic documents through association with an HTML.

As is clear from the above, the audible word tags in accordance with the present invention are, using the system of the present invention, embeddable into communications or documents of a variety of electronic formats.

Representative Implementation

What follows is a representative implementation of the present invention, specifically an example of an enterprise implementation of the present invention.

The computer system of the present invention may be configured so that it is automatically embedded in correspondence or documents, and other information objects, or a sub-set thereof, such that the audible word tag is operable to migrate for example document to document.

The present invention is operable in an enterprise computer system environment to provide access to the audible name tags for use in consumer and enterprise situations, whether in documents or communications.

The audible name tags may be collected for the enterprise personnel, or for selected groups thereof. The collection of the audible name tags may, for example, be associated with the recording of voicemail recordings introducing the pronunciation of the names of the individuals. The computer system of the present invention may be integrated with the VoIP phone system or PBX server of the present invention for the purpose of obtaining the recording of the audible name tag. The audible name tags may be stored to a database associated with the computer system, which may be hosted on one or more servers that are part of the computer system, or of a distributed cloud.

The computer system is then operable to provide a standard hypertext web link to allow the playback of the audible name tag. The link may take for example the form of a hashed code with no identifiable information. Or an enterprise may choose a custom link. The links can be customized by operation of the present invention to meet the objectives of the enterprise user.

The computer system may be implemented as a web server associated with a web server application, which may be implemented for example as an API, which enables the creation, update, deletion, and other management functions associated with audible name tags. The API may also be operable to determine the source of a request for an audible name tag, and optionally determine if the requestor is authorized to access the audible name tag. The API may also be operable to access the specific database record containing the relevant audible name tag, and to establish the format thereof, for example whether it is in MP3 format or in WAV format.

The computer system of the present invention is designed to enable integration with existing systems so as to avoid placing additional demands on resources including overburdened corporate IT departments.

For example, the computer system and computer program of the present invention may be integrated with a third party email application. One example of such an implementation of the present invention is provided below.

An email plug-in may be provided, for example for Microsoft OUTLOOK™. In general, the plug-in may take two forms: a) Additional, context-sensitive buttons to be located for example in the “Home” ribbon (or alternate ribbon), or b) Adding an additional, context-sensitive ribbon menu that will contain all the buttons required. Accordingly, the audible name tag and related content may only be visible when enabled by operation of the plug-in and when a message containing the audible name tag is selected by the user. The plug-in is then operable to insert into e-mail the audible name tag with the specific identifying tags, as further explained below, which improves security of the solution to prevent spoofing of the audible name tags and hacking attacks.

The plug-in may be provided with custom buttons, whether as a contextual ribbon or context-sensitive buttons added to an existing ribbon. A button linked to the solution of the present invention, may “flash” when a message containing an audible name tag is selected. Initiating this button will open the appropriate link to access and play the associated audio name tag by operation of API.

The plug-in opens the most recent audible name tag, operating under the assumption that signatures will be added to the end of messages.

A “Colony” button may be provided. This button is intended to act as a drop-down that will contain a list of all audible name tags found in the message. The individual audible name tags may be listed according to the “(Name)” field described below. This button enables the user to select the particular linked audible name tags to be used.

A “Nest” button may also be provided. This button will import user data from the solution of the present invention into the email application contacts list. Similar to the “Colony” button, this button will provide the user with a drop-down of names from the message. If the user selects one of the names, they will be greeted with a confirmation message before the user's information is imported into a new contact entry.

A “Home” button may also be provided. This button may open a web page associated with the technology described in this invention, which may provide information regarding the service described herein.

Social Networking

The computer system of the present invention may also provide access to a web page that enables the user to optionally create and manage the audible name tag, and also other information such as text, photos and other information, including information customary for use on social networking sites. The computer system may include or be linked to a social networking engine that enables users to create communities, for example built around common ethnic, cultural, or geographic background. For example, the social networking engine may include or be linked to an analytics engine that is operable to analyze the profiles of individuals to attempt to determine social or cultural attributes of the individual, associated with his/her name and/or associated with his/her personal recording of the pronunciation of his/her name. Based on a number of factors associated with a first individual, such as for example his/her education, job title, nature of work or interests, and/or the location where he/she lives or works, the social networking engine is operable to generate a matching profile for the first individual, which is then compared to matching profiles of other individuals associated with the social networking engine, to generate one or more suggestions of other individuals with whom the first individual may want to connect, for example, through a functionality similar to LinkedIn™ or in fact based on the present invention being integrated with LinkedIn™. Common heritage can be a powerful basis for creating connections, including business connections, especially in expatriate communities for example. The users of the present technology, in general, will care about their heritage, that is why they are creating the audible word tag for their names, for example. This user base in turn provides a group likely to be interested in networking with like minded individuals, whether based on shared heritage, or based on feeling connected to a linguistic or cultural group. For example, an individual who spent years living in a particular country may be interested in a different country in connecting with members of the business community who have roots in the country where he/she lived.

Possible Implementation of Audible Name Tags

As mentioned earlier, the audible name tags may bear consistent format for identification and security purposes. Any tag that does not conform to these specifications may be ignored by the described plug-in. The below is an example of a possible tag format, configured for this purpose.

The explanation of a possible file format supporting audible name tags in particular indicates to a skilled reader possible file formats for supporting audible word tags more broadly.

The tag may always be in the format “\ANT_vibes:############_(Name)V” where:

a) “\ANT_vibes:” is always present verbatim as an identifying tag for our software plug-ins to search on.

b) “############” is a 12-digit number containing only numbers (0-9) and no escape characters or symbols of any kind.

c) “_” is always present verbatim, acting as a separator between the number and the alphanumeric name.

d) “(Name)” is an alphanumeric name for the user. This will only be used to identify the user for UI plug-in. * It is recommended to guard against escape characters in this field.

e) “\” is always present verbatim, indicating the end of the ANT field. Everything after this tag is to be discarded by our plug-in.

The 12-digit number is to be used to uniquely identify each user. It is the user's identification number and has the solitary purpose of acting as a UID for each user. The computer system can rely on this number to be strictly numerical (0-9) and any AID that is not strictly numerical should be discarded without further evaluation.

The audible name tags may take the form of simple standard hypertext web links. The computer system of the present information may host all customer information on one or more computer servers, both textual and audio data, and deliver the audio tags via web links processed by the computer servers. The use of a web link allows simple inclusion into any enterprise application that allows text to be entered.

For example, in connection with enterprise email application, the audible name tags in accordance with the present invention may be presented as a linked image, perhaps in the user's signature file. Clicking on the image would play the audio name tag.

The users of the present computer system may be identified in a variety of ways. In one implementation, the user's email address may be used to identify the user, assuming the consent of the user. In the case of an enterprise deployment, corporate telephone extension number, or a combination of name and extension could replace the email address.

Significantly, often individuals prefer a specific pronunciation, accent or intonation for a particular audible word tag. The present invention enables the recording and use of recordable audible word tags.

Other Applications and Use Cases

It should be understood that the audible word tags may be linked to other forms of communication such as telephone communications or videoconferencing. Provided that a telephone system, videoconferencing system, or other communication system is linked to an address book component, audible word tags in accordance with the present invention that are included in the address book component or linked thereto, may be used in connection with the use of a telephone system or videoconferencing system. For example, in connection with a telephone system connected to an address book, either when a call is placed or a call is received, the system may be operable to (A) to check whether there is an audible word tag associated with the person calling or being called, and (B) before connecting the call, accessing and playing the audible word tag to provide the caller on an outbound call, or the person being called on an inbound call, the pronunciation of the name of the person being called or the person calling, or other information associated with the audible word tag. Alternatively, the telephone system, using a suitable interface, may enable the user once a call has been initiated to automatically access the audible word tag, if it is associated with a particular individual involved in the call, mute the phone call, and play the audible word tag to access pronunciation information required during the call.

Similarly, in connection with a videoconferencing system, before connecting a videoconference, or before a participant joining a videoconference, the system may be operable to (A) check whether there is an audible word tag associated with the person or organization calling or being called in an address book linked to the system, and (B) before connecting the person or organization to the videoconference, accessing and playing the audible word tag to one or more other participants, thereby providing the pronunciation of the name of the person being called or other information associated with the audible word tag. Alternatively, the videoconferencing system may enable one or more participants to during a videoconference, use a suitable interface, to access the audible word tag, if it is associated with a particular individual or organization involved in the call. Preferably, this function is implemented for example by muting audio from a first location while participants at the first location access one or more audible word tags associated with the participants at a second location. In a particular implementation of the present invention, a web interface may be associated with the operation of the videoconferencing system, or with the operation of a web based videoconferencing solution such as WebEx™. The web interface may display a list of participants, including a logo associated with the operator of the website indicating when an audible word tag of the present invention is available. The system may be operable to mute the audio function while playing back the audible word tags.

As previously mentioned, a possible implementation of the audible word tags is as audible product tags or “APT”. In one implementation, a CMS also includes functionality for managing the developing and ordering of prints for print material, such as flyers and the like. Alternatively, this functionality may be provided using a computer system that manages the creation of print media, and the ordering of print copies thereof.

The audible word tag creation and management technology of the present invention may be integrated with such solutions. For example, the CMS may enable a user to create or manage the creation of multiple digital media objects that are linked to audible word tags. For example, a user of a CMS that links to the computer system of the present invention, or incorporates the functionality of the present invention, may create one or more promotional digital media objects, for example various versions of a flyer that promote a wine product. One version of the flyer may be designed and laid out, and created, so that it is linked to audible product content such as a description of the wine by a recognized wine critic in his/her voice. The flyer is likely to be made available in various media, and for consumption using various communication channels and network-connected devices. For example the flyer may exist in different lengths in print form; as a web page or micro site, optimized for different types of devices. The user may link a GUI element that is associated with the mentioned audible word tags in some or all of these promotional digital media objects, which take the form of an audible product tag. Also, an in store print brochure or sign may contain a linked to the audible promotional product tag. In each case the computer system provides access to the audible word tags, which the user can update from time to time and which maintains the audible word tags in a way that is accessible to various individuals targeted by the promotional campaign. The user has the flexibility of integrating the audible word tag with the various digital media objects as he/she sees fit from a promotional perspective. The user has access to the necessary infrastructure to support the creation of the audible word tags (the wine critic could create these from his/her mobile device for example, and could create an update on request of the user) and also the distribution of these audible word tags with much less effort that would have been previously possible. Essentially, audible word tags, by operation of the computer system of the present invention can be dragged and dropped into various media, including as audible product tags.

One advantage of the computer system of the present invention is that audible word tags may be customized, edited, and also modified or re-captured at any time. This allows users to update their promotional campaigns from time to time.

The present invention may also be extended such that the selection of particular audible word tags is automatic and is based on for example outside parameters such as time of day, day, season, weather, and so on. This allows greater adaptability of campaigns to changing circumstances, using engaging audible content. Other parameters may include the location of the user's network-connected device. This way for example access of audible content through a link or APT QR code will provide access to the latest content automatically. APTs are particularly advantageous for providing changing information, for example, E. coli count in popular beaches to advise beach users whether the water is safe for swimming or not. Another example of APT use is in parks to provide audible advice on latest weather conditions or fire risk.

In one representative workflow, an enterprise client of the computer system may: (A) purchase a certain number of APTs; (B) a user signs in to the computer system of the present invention and accesses tools for initiating the creation of APTs such as sending an invitation to create an APT within defined parameters for example to the wine critic in the example above; (C) the computer system manages the process of creating the APTs and stores them as a unique URLs in the computer system; (D) the computer system creates various mechanisms for distribution of the APT based on parameters defined by the user including generation of associated QR codes or custom links incorporating the enterprise's domain; (E) these mechanisms for distribution can be inserted in various media objects, including print media; (F) a user accesses the APTs through the computer system using the QR codes for example scanned using his/her mobile phone.

APTs may be used to convey information in an engaging and accessible format consisting of for example (A) product reviews (by industry experts), (B) words from the product's producer/president/public figure, (C) highlights of product features/quality/their ingredients and their benefits, (D) testimonials, (E) personal messages for loved ones (tomb stones), (E) celebrity or executive endorsements.

Another advantage of the present invention is that audible information can be more efficient than print media in providing access to a wide variety of information. This is advantageous as an example to providing access to information in a wide variety of languages. For example, a QR code may provide access in a store to messaging in a particular language. Alternatively, the QR code may provide a link to a menu which in turn allows a user to select the language in which they desire to obtain important product information. Printing the same information in the languages available using the present invention may not be viable. Whereas providing access to such information in a wide variety of languages is very useful in engaging customer of different cultural or language backgrounds, and enables deployment of virtual sales agent of features that were not previously possible.

A skilled reader will also appreciate that with the proliferation of accessibility to such useful and novel voice information, it will be necessary to have a computer system that manages the capture of audible word tags by one or more individuals who speak a particular language perfectly, across numerous campaigns and enterprise clients. The computer system of the present invention also manages a hub of talent available for creation of audible word tags, which based on use of the computer system, can be captured easily electronically, and then distributed conveniently through the computer system.

As a further example the computer system of the present invention may be linked for example to a conference registration web site to enable conference participants to create audible name tags with their profiles associated with the conference management platform used by the organizers.

In another possible implementation of the present invention, APTs may be associated with transit stop infrastructure for example to access up to date transit schedule information in audible format. This is especially useful to transit riders who are visually impaired. Alternatively, a user's network-connected device may include a mobile application that (A) detects when the user is within defined distance of a transit stop, and (B) if s/he, is the mobile application automatically obtains an up to date audible transit schedule update in audible from the computer system of the present invention.

The above-described embodiments of the present invention can be implemented in any of numerous ways. For example, the embodiments may be implemented using hardware, software or a combination thereof. For example, the functions described above may be integrated with the hardware and/or software functions of a wireless device, or implemented as part of a communication system such as an email system or unified messaging system. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments of the present invention comprises at least one computer-readable storage medium (e.g., a computer memory, a floppy disk, a compact disk, a tape, and/or other tangible storage media.) encoded with a computer program (i.e., a plurality of instructions), which, when executed on a processor, performs the above-discussed functions of the embodiments of the present invention. The computer-readable medium can be transportable such that the program stored thereon can be loaded onto any computer system resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

It should be appreciated that in accordance with several embodiments of the present invention wherein processes are implemented in a computer readable medium, the computer implemented processes may, during the course of their execution, receive input manually (e.g., from a user), in the manners described above.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method of operating a computer to perform a computer-implemented process for generating and sharing an audible word tag for one or more words, the method comprising:
(a) generating a profile for one or more individuals or entities and enabling one or more individuals or entities to record an audio recording for one or more words to generate an audible word tag associated with the profile; and
(b) linking, or facilitating the linking, by one or more computer processors, the audible word tag to one or more items of electronic correspondence, the audible word tag accessible by a receiver of the electronic correspondence to initiate the playback of the audio recording.

2. The method of claim 1, wherein the audible word tag is personalized using the voice of the one or more users.

3. The method of claim 2, wherein the audible word tag is made accessible from a variety of computer systems, communication devices, and communication platforms.

4. The method of claim 3, wherein the audible word tag is generated with the assistance of a computer implemented assistant.

5. The method of claim 1, wherein the audible word tag is associated with the pronunciation of a name of an individual, company, product, technical term, scientific term, or place name.

6. The method of claim 1, wherein the audible word tag is associated with the voice description of an individual, company, product, technical term, scientific term, or place name.

7. A computer system for generating and sharing an audible word tag for one or more words, the computer system comprising:
(a) at least one tangible memory that stores processor-executable instructions for generating and sharing an audible word tag for one or more words; and
(b) at least one hardware processor, coupled to the at least one tangible memory, that executes the processor-executable instructions to:
(i) generate a profile for one or more users and enabling or more individuals to record an audio recording for one or more words to generate an audible word tag associated with the profile;
(ii) enable the linking of the audible word tag to one or more items of electronic correspondence; and
(iii) enable a computer device associated with one or more recipients of the items of electronic correspondence to initiate access to the audible word tag so as to enable the playback of the audio recording.

8. The computer system of claim 7, wherein the computer system provides access to a computer network accessible attendant for guiding the one or more individuals through the generation of the audible word tag.

9. The computer system of claim 7, wherein the computer system is operable to enable the audible word tag to be made available in connection with communications involving one or more individuals or organizations associated with the audible word tag.

10. The computer system of claim 8, wherein the computer system is operable to link one or more audible word tags with associated entries in an address book, so as to automatically make the audible word tag accessible in conjunction with a communication from or to one or more individuals or organizations associated with the applicable audible word tag.

11. The computer system of claim 8, wherein the computer system is linked to a database that includes a plurality of profiles associated with audible word tags, and the computer system is linked to a computer implemented social media engine that analyzes the profiles and matches profiles using a computer implemented matching routine, and based on such matches suggests possible connections to users of the computer system, wherein the audible word tags are used in connecting two or more users who have accepted connections suggested by the computer system.

12. The computer system of claim 7, wherein the computer system is linked to a telephone communication system, and the computer system is operable on placement or receipt of a telephone call to access the audible word tag for the caller or entity being called, if available, and access and playback the associated audio recording to either introduce the caller to the person or entity being called, or to provide the audio recording to the caller in connection with calling the person or entity being called.

13. The computer system of claim 12, wherein the computer system is further operable to enable a person participating in a telephone call to access the audible word tag, and mute the telephone while playing back the associated audio recording.

14. The computer system of claim 7, wherein the computer system is linked to a videoconferencing system, and the computer system is operable on joining a participant to a videoconference to access the audible word tag for the participant, if available, and playback the associated audio recording.

15. The computer system of claim 14, wherein the computer system is further operable to enable a participant in the videoconference to access the audible word tag, and mute the videoconference from a first location while playing back the audio recording for an audible word tag associated with an individual or organization associated with a second location.

16. A non-transient computer readable medium comprising software for execution by hardware to perform a plurality of steps, wherein the steps include:
enabling a plurality of individuals to each record an audio recording to generate an audible word tag associated with a profile;
linking of each said audible word tag to each of a plurality of items of electronic correspondence; and
associating, with each of a plurality of recipients, each said item of electronic correspondence to initiate access to the audible word tag for playback of the audio recording.

17. The non-transient computer readable medium as defined in claim 16, wherein the steps further comprise providing access to a computer network accessible attendant for guiding each said individual through the generation of each said audible word tag.

18. The non-transient computer readable medium as defined in claim 16, wherein the steps further comprise enabling each said audible word tag to be made available in connection with communications involving each said individual associated with each said audible word tag.

19. The non-transient computer readable medium as defined in claim 17, wherein the steps further comprise linking each said audible word tag with associated entries in an address book, so as to automatically make the audible word tag accessible in conjunction with a communication from or to each said individual associated with the applicable audible word tag.

20. The non-transient computer readable medium as defined in claim 17, wherein the steps further comprise:
linking to a database comprising a plurality of said profiles each respectively associated with one said audible word tag;
linking to a computer implemented social media engine that:
matches each said profile; and
for each said match, suggests a connection to a plurality of users for acceptance by each said user; and
connecting each of a plurality of said users who accepted the suggested connection, wherein each said connection of each said plurality of said users uses one said audible word tag used for the connection.

21. The non-transient computer readable medium as defined in claim 16, wherein the steps further comprise:
linking to a telephone communication system;
accessing one said audible word tag, upon placement or receipt of a telephone call on the telephone communication system by a caller or an entity being called by telephone communication system; and
playing back an audio recording associated with the accessed one said audible word tag to:
introduce the caller to the person or entity being called; or
provide the audio recording to the caller in connection with calling the person or entity being called.

22. The non-transient computer readable medium as defined in claim 21, wherein the steps further comprise:
enabling a person participating in the telephone call to access the audible word tag; and
muting audio output of the telephone while playing back the associated audio recording.

23. The non-transient computer readable medium as defined in claim 16, wherein the steps further comprise:
linking to a videoconferencing system;
joining a participant to a videoconference of the videoconferencing system;
accessing, upon the joining of the participant, one said audible word tag; and
playing back an audio recording associated with the accessed one said audible word tag.

24. The non-transient computer readable medium as defined in claim 22, wherein the steps further comprise:
enabling the participant in the videoconference to access the audible word tag; and
muting audio output of the videoconference from a first location while playing back the audio recording associated with the accessed one said audible word tag at a second location.
